(19) United States
(12) Patent Application Publication
(10) Pub. No.: US 2015/0339932 A1
(43) Pub. Date: Nov. 26, 2015

(54) METHODS AND SYSTEMS TO GENERATE THE ATC CENTER NAMES LIST BASED ON AT LEAST ONE FLIGHT PLAN

(71) Applicant: Honeywell International Inc., Morristown, NJ (US)

(72) Inventors: Prashanth Ramanna, Bangalore (IN); Thomas D. Judd, Woodinville, WA (US)

(73) Assignee: Honeywell International Inc., Morristown, NJ (US)

(21) Appl. No.: 14/282,872

(22) Filed: May 20, 2014

(51) Int. Cl. G08G 5/00

(52) U.S. Cl. CPC G08G 5/0034

(57) ABSTRACT

A method to provide access to air traffic control centers to a crew member for context management (CM) logon is provided. The method includes accessing a flight plan for an aircraft at a processor; accessing a listing of air traffic control centers; generating a subset of the air traffic control centers at the processor; and displaying the subset of the air traffic control centers as at least a part of a prioritized listing of the air traffic control centers on a display for the crew member. The generating is based on at least one of: an ATC-center authority coverage area overlapping a flight path associated with the flight plan; and a pre-selected distance from the flight path.

### BACKGROUND

Air traffic control (ATC) centers are used at most airports to coordinate take-offs, landings, and general aircraft traffic around the airport. Traditionally, a pilot uses a radio to speak to an ATC center to request permission or to receive instructions from the ATC center. With increasing air traffic, it has become difficult for ATC centers and pilots to process all of the oral communications with aircraft without error. Consequently, data link applications have been developed to provide textual communications between pilots and air traffic controllers.

One of these data link applications, called Controller Pilot Data Link Communication (CPDLC), provides for the direct exchange of text-based messages between a controller and a pilot. The CPDLC application enables the pilot to communicate electronically with an ATC center controller by guiding the pilot through a series of screen configurations or displays that either elicit flight information from the pilot or notify the pilot regarding flight information. The CPDLC application may be part of a larger flight information/control program or may serve as a stand-alone program.

ATC centers deploy data link applications, such as CPDLC and Context Management (CM), which allow the ATC controller and a pilot to communicate via electronic messages delivered through the Aeronautical Telecommunication Network (ATN). To have electronic message communication through CPDLC and CM, the pilot must first select an ATC center from a list of available ATC centers using a flight computer. In current CPDLC systems, avionics systems such as a Communication Management Unit (CMU) or a Flight Management Computer (FMC) include interfaces configured to allow pilots and/or flight crews to select the desired ATC center from the list of available ATC centers. As more and more ATC centers are added, the pilot will have search through a longer list of ATC Centers with extended head-down time looking for the appropriate ATC center from the long list. Typically, aircraft flight computers have limited resolution displays, complicating the efficient presentation of available ATC centers.

A Human-Machine Interface (HMI) that is common to many aircraft avionics is the Multifunction Control Display Unit (MCDU). The MCDU has a display area of only 14 lines in height by 24 characters in width. In current applications, the pilot and/or flight crew is required to scroll through the list of available ATC centers to find and select the desired ATC center. In current applications, the ATC centers are listed in the order they are stored in a database. The database is typically static with no hierarchal order or logic to facilitate quick selection. Thus, pilots and/or flight crew are often required to scroll through multiple screens of ATC center lists to find the appropriate ATC center.

### SUMMARY

The present application relates to a method to provide access to air traffic control centers to a crew member for context management (CM) logon. The method includes accessing a flight plan for an aircraft at a processor; accessing a listing of air traffic control centers; generating a subset of the air traffic control centers at the processor; and displaying the subset of the air traffic control centers as at least a part of a prioritized listing of the air traffic control centers on a display for the crew member. The generating is based on at least one of: an ATC-center authority coverage area overlapping a flight path associated with the flight plan; and a pre-selected distance from the flight path.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of a computer system that can implement the methods of the invention;

FIG. 2 is a block diagram of a specific embodiment of a computer system that can implement methods of the invention;

FIG. 3 is a block diagram of an example Aeronautical Telecommunication Network (ATN) Network Service Access Point address format for an Air Traffic Control (ATC) center;

FIG. 4 is a block diagram of a specific embodiment of a computer system that can implement methods of the invention shown with a flight path and air traffic control centers associated with the flight path;

FIG. 5 is a block diagram of a specific embodiment of a computer system that can implement methods of the invention shown with a primary flight path and an alternate flight path and the air traffic control centers associated with the flight paths;

FIG. 6A depicts an exemplary prior art listing of air traffic control centers on a display;

FIGS. 6B-6D depict exemplary prioritized listings of air traffic control centers on an embodiment of a display; and

FIG. 7 shows a flow chart of an embodiment of a method to provide access to air traffic control centers to a pilot.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The time that the pilot spends looking at the display screen showing the listing ATC centers from which to select an air traffic control center for communication is referred to herein as “head-down time” or “heads-down time”. Since the pilot or flight crew member is unable to focus on other, potentially safety-critical, matters during the head-down time, it is important, for safety reasons, to limit the amount of head-down time. If a flight crew member is required to scroll through a long list of ATC centers to select a preferred ATC center, the head-down time can become excessive. The display screen showing the listing ATC centers from which to select an air traffic control center for communication is referred to herein as a “logon screen” that presents ATC centers that are nearby for logon. The terms “pilot”, “aircraft crew”, and “flight crew member” are used interchangeably herein.

The present invention is directed to methods and systems for generating a data link air traffic control center menu. In general, the methods and systems provide for organizing and displaying on a first screen at least a portion of a prioritized subset of Air Traffic Control (ATC) center objects in a database. The air traffic control centers are selected as prioritiy, at least in part, based on at least one of a pre-selected distance from a flight path associated with the flight plan and an ATC-center authority coverage area overlapping the flight path. The ATC-center authority coverage is the airspace area over which the ATC center has ATC control authority. The “ATC-center authority coverage area overlapping a flight path” is defined herein as the distance along the line of a flight path that intersects with the ATC-center authority coverage area. The subset of ATC centers is taken from from a long list of possiblities in order for the pilot to efficiently select a desired ATC center. Since the subset of air traffic control centers is shown on the first displayed screen (or a first two screens), the aircraft crew workload is reduced and pilot head-down time is minimized.

The head-down time is reduced by displaying the ATC centers in a prioritized manner. In one implementation of this embodiment, the system is designed to determine the distance along the line of a flight path (associated with a filed route) that intersects with the ATC-center authority coverage area and to list at the top of the display screen the air traffic control center with the longest intersection. The second ATC center displayed on the display screen has the second longest intersection with the ATC-center authority coverage. Likewise, the third ATC center displayed on the display screen has the third longest intersection with the ATC-center authority coverage, and so forth for all the ATC centers with ATC-center authority coverage that overlaps with the flight path.

In another implementation of this embodiment, the system is designed to determine which air traffic control centers are the shortest distances from a filed route (e.g., a flight plan) and to list those air traffic control centers at the top of the display screen. By prioritizing the air traffic control centers, the pilot selects the preferred ATC more quickly and easily with less head-down time. Thus, the ATC Centers are organized to present on the first page of the display those ATC centers in proximity to the flight path or having an ATC-center authority coverage area overlapping the flight path associated with one or more of: 1) a flight plan of the aircraft; 2) alternate flight plans of the aircraft; 3) a current route of the aircraft; and 4) just off of (proximal to) the current route of the aircraft.

In yet another implementation of this embodiment, the system is designed to determine the ATC-center authority coverage area overlapping the flight path associated with a route and to also determine which air traffic control centers are the shortest distances from the route. For example, the processor can execute an algorithm to sort the prioritization of the ATC centers to reduce the number of handoffs required during the flight of the aircraft along the flight path.

In yet another implementation of this embodiment, the system is designed to determine the location of an airborne aircraft en route to a destination in order to determine which ATC centers should be listed first of those along the route. For example, if the pilot requests and obtains clearance to deviate from the filed flight plan, the organization of the listing of ATC centers is adjusted to place those ATC centers along and near the new route at the top of the listing. In this case, the ATC centers with ATC-center authority coverage area overlapping the flight path and/or ATC centers along and near the new route will be displayed in the first screen.

The present methods can be implemented in a communication management function (CMF) of a communication management unit (CMU); in a flight management computer (FMC) such as an FMC hosting Controller Pilot Data Link Communication (CPDLC) applications; or in any other avionics computer in an aircraft. The present methods can also be a part of the communication protocols for aeronautical telecommunication network (ATN) CPDLC systems.

The present methods can be implemented for an aircraft by modifying conventional avionics software to add appropriate logic steps to perform the methods. The prioritizing and/or sorting used in a particular approach can be implemented according to any of the specific implementations described below. The methods and systems of the present invention are described in further detail as follows with reference to the drawings.

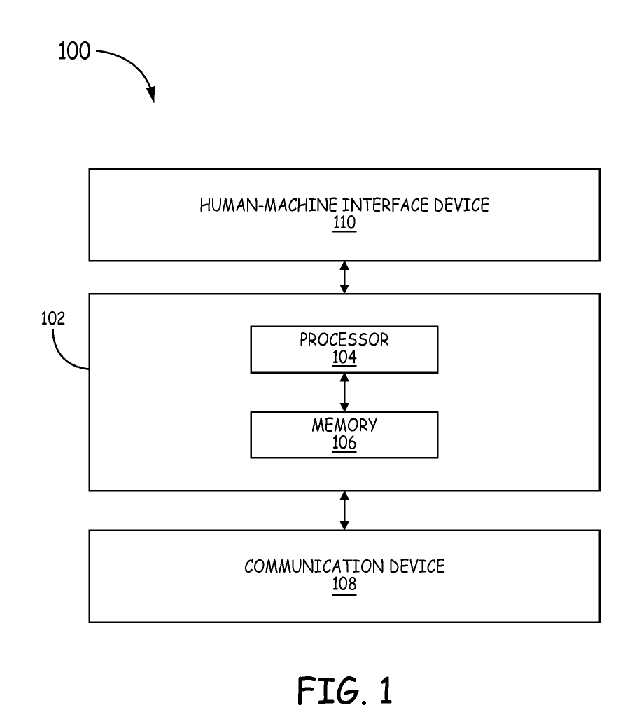

FIG. 1 is a block diagram of a data communication computer system 100 that can implement the present method. The computer system 100 can be implemented as a communications management unit, a flight management computer, a communications management function, a flight management function, or any other avionics computer. The computer system 100 comprises a processing and storage platform 102, which includes at least one processor 104 and at least one memory 106 in operative communication with processor 104. The computer system 100 can also incorporate a data communication device 108, to enable transmission and reception of various communications and data link messages such as CPDLC application messages. The data communication device 108 is in operative communication with processor 104 and memory 106. The computer system 100 also includes a Human-Machine Interface (HMI) device 110, such as those currently used by pilots in the cock-pits of various aircraft. Examples of HMI device 110 include a Multi-Control Display Unit (MCDU) and a graphically controlled display like Multi Function Display (MFD) system. Suitable exemplary display units also include a display associated with an Electronic Flight Bag (EFB).

The processor 104 can be implemented using software, firmware, hardware, or any appropriate combination thereof, as known to one of skill in the art. By way of example and not limitation, hardware components for processor 104 can include one or more microprocessors, memory elements, digital signal processing (DSP) elements, interface cards, and other standard components known in the art. Any of the foregoing may be supplemented by, or incorporated in, specially-designed application-specific integrated circuits (ASICs) or field programmable gate arrays (FPGAs). In this exemplary embodiment, processor 104 includes or functions with software programs, firmware, or other computer readable instructions for carrying out various process tasks, calculations, and control functions, used in the present method. These instructions are typically tangibly embodied on any appropriate medium used for storage of computer readable instructions or data structures.

The memory 106 can be implemented with any available computer readable storage media that can be accessed by a general purpose or special purpose computer or processor, or any programmable logic device. Suitable computer readable media may include storage or memory media such as magnetic or optical media. For example, storage or memory media may include conventional hard disks, Compact Disk—Read Only Memory (CD-ROM), DVDs, volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), and the like), Read Only Memory (ROM), Electrically Erasable Programmable ROM (EEPROM), flash memory, and the like. Suitable processor-readable media may also include transmission media such as electrical, electromagnetic, or digital signals, conveyed via a communication medium such as a network and/or a wireless link. Combinations of the above are also included within the scope of computer readable media.

The method of the invention can be implemented in computer readable instructions, such as program modules or applications, which are executed by a data processor. Generally, program modules or applications include routines, programs, objects, data components, data structures, algorithms, and the like, which perform particular tasks or implement particular abstract data types. These represent examples of program code means for executing steps of the methods disclosed herein. The particular sequence of such executable instructions or associated data structures represent examples of corresponding acts for implementing the functions described in such steps.

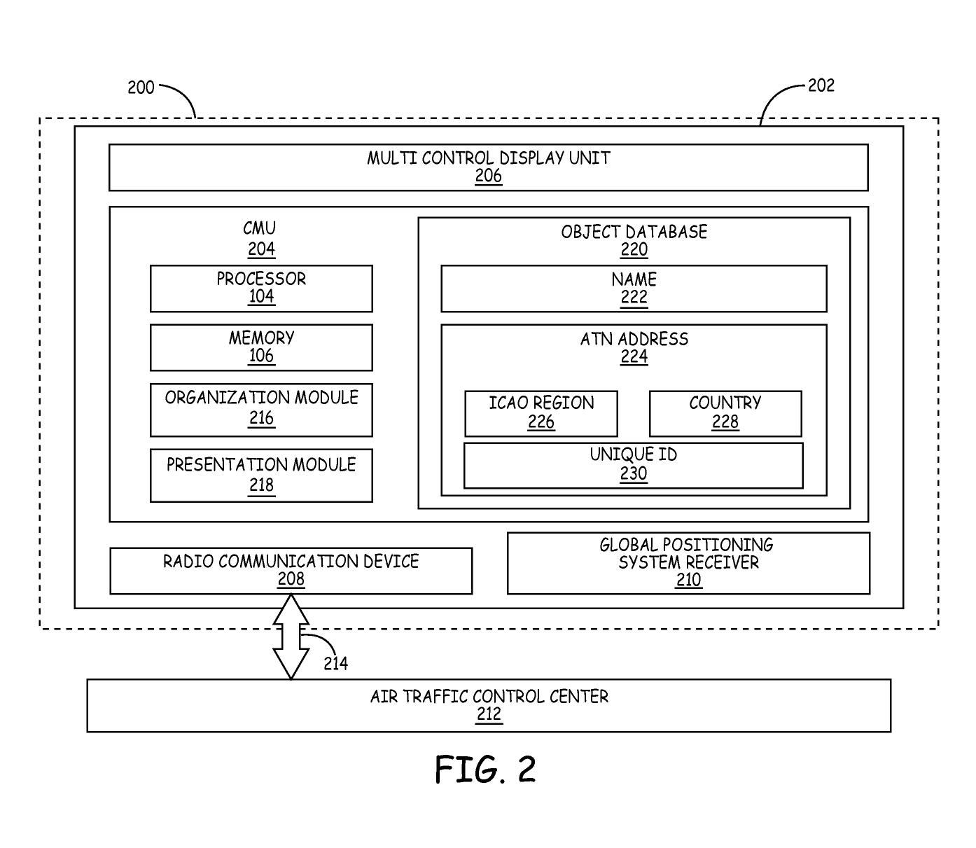

FIG. 2 is a block diagram of an aircraft 200 having a computer system 202 that can implement a method of the invention. The computer system 202 is typically onboard aircraft 200. The computer system 202 is implemented using a communication management unit (CMU) 204, though it can also be implemented as a flight management computer, a communications management function, a flight management function, or any other avionics computer according to computer system 100 of FIG. 1. The communication management unit 204 performs functions similar to processing and storage platform 102 and includes processor 104 and memory 106 as described with reference to computer system 100 of FIG. 1.

The computer system 202 also includes a Multi-Control Display Unit (MCDU) 206, a specific type of user interface device similar to HMI device 110 of FIG. 1. In other embodiments, a graphically controlled display like MFD or other display/control system can be used instead of MCDU 206. The MCDU 206 is used to display information to, and receive input from, pilot and/or flight crew onboard aircraft 200. The computer system 202 also includes a radio communication device 208. The radio communication device 208 is configured to communicatively connect with an air traffic control center 212 via a data link 214. The method discussed below aids the pilots and/or flight crew in the selection of air traffic control center 212 from a plurality of air traffic control centers. In some embodiments, a global positioning system receiver 210 is included and configured to aid the pilot and/or flight crew in the selection of air traffic control center 212 according to the methods below.

The communication management unit 204 of computer system 202 includes an organization module 216, a presentation module 218, and an object database 220. In some embodiments, organization module 216 and presentation module 218 are implemented using processor 104 and memory 106. The organization module 216 is configured to organize a plurality of ATC center objects stored in object database 220 in a prioritized manner. The operation of organization module 216 is detailed in a method described below. The presentation module 218 is configured to present the plurality of ATC center objects from object database 220 to the pilots and/or flight crew according to the prioritized organization performed by organization module 216. The operation of presentation module 218 is detailed in a method described below. The object database 220 typically includes a plurality of ATC center objects. Each individual ATC center object in object database 220 includes a name 222 and an ATN address 224. Each name 222 is typically a descriptive name of a specfic ATC center represented by the particular ATC center object in object database 220. Each name 222 is typically recognizable by the pilots and/or flight crew interacting with MCDU 206. The ATN address 224 is associated with each name 222 and represents the actual ATN address of the air traffic control center represented by the particular ATC center object in object database 220.

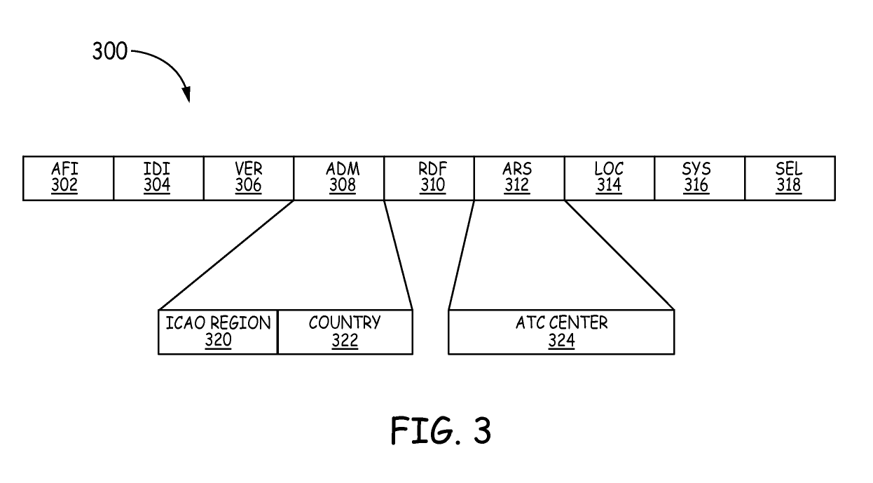

FIG. 3 is a block diagram of an example ATN address format 300. Though the ATN address format 300 has been previously set, it will be described here because parts of it are used in the methods of the invention. The ATN address format 300 typically includes a plurality of different fields containing information about a particular ATC center associated with a particular ATN address. Specifically, the ATN address format 300 includes an Authority and Format Identifier (AFI) field 302, an Initial Domain Identifier (IDI) field 304, a Version Identifier (VER) field 306, an Administration Identifier (ADM) field 308, a Routing Domain Format (RDF) field 310, an Administrative Region Selector (ARS) field 312, a Location Identifier (LOC) field 314, a System Identifier (SYS) field 316, and a Network Service Access Point (NSAP) Selector (SEL) field 318. The ADM field 308 and the ARS field 312 are used in implementation of specific embodiments of the invention.

The International Civil Aviation Organization (ICAO) is part of the United Nations that codifies principles and techniques of international aeronautical navigation. The ICAO has divided the earth into nine geographic ICAO regions 320: Africa, Asia, Caribbean, Europe, Middle East, North America, North Atlantic, Pacific, and South America. The ATN address representing a particular ATC center typically includes ADM field 308, which is divided into a first portion identifying an ICAO region 320 and a second portion identifying a country 322 where the ATC center represented by the particular ATN address is located. Each of the ICAO regions 320 is typically represented in the first portion of ADM field 308 of an ATN address using a predetermined hexadecimal value. Typically, each ICAO region 320 is assigned the following hexadecimal values: Africa is 0x80, Asia is 0x81, Carribean is 0x82, Europe is 0x83, Middle East is 0x84, North America is 0x85, North Atlantic is 0x86, Pacific is 0x87, and South America is 0x88. The ICAO region 320 from the first portion of ADM field 308 is typically stored in object database 220 as an ICAO region 226 in ATN address 224 as shown in FIG. 2.

A second portion of ADM field 308 indicates country 322 where the ATC center represented by a particular ATN address is located. Each country 322 within a particular ICAO region 226 is typically represented in the second portion of ADM field 308 of an ATN address using the ASCII hexadecimal equivalents of the country's two letter country code. For example, Germany has a two letter country code “DE”. Thus, its ADM field would include the hexadecimal code for Europe's ICAO region 320 followed by the hexadecimal representation of “DE”, or 0x834445. Similarly, these other example European countries have the following ADM codes: Ireland is 0x834945 (“IE”), Italy is 0x834954 (“IT”), Luxemburg is 0x834C55 (“LU”), the Netherlands is 0x834E4C (“LU”), Portugal is 0x835054 (“PT”), Spain is 0x834583 (“ES”), and the UK is 0x834742 (“GB”). This pattern of ICAO region code+two letter country code is followed for countries in all of the ICAO regions. In some embodiments, other sub-categories, other than countries, are also accessible under a particular ICAO region 320. For example, in some embodiments, Eurocontrol has an ADM code of 0x836575 (“eu”), NATO in Europe has an ADM code of 0x836E61 (“na”), and the European Top Level Backbone has a ADM code of 0x8380BB. The country 322 from the second portion of ADM field 308 is typically stored in object database 220 as a country 228 in ATN address 224 as shown in FIG. 2.

The ATN address representing a particular ATC center typically includes ARS field 312, which uniquely identifies a specific ATC center 324 represented by the particular ATN address. The unique identification for ATC center 324 is typically stored in object database 220 as a unique ID 230 in ATN address 224. Thus, ATN address 224 uniquely identifies each individual ATC center represented by a particular ATC center object by unique ID 230, and also identifies both ICAO region 226 and country 228 in which each individual ATC center represented by a particular ATC center object is located.

In one implementation of this embodiment, the ATN addresses are replaced by an IP or an internet address. In another implementation of this embodiment, the list of air traffic control centers and the addresses (ATN and/or IP or internet address) are loaded into a database. In other embodiments, the list of air traffic control centers and the addresses are one or more of hard coded, uplinked, or available externally. For example, externally available list of air traffic control centers and the addresses can be found on an external server.

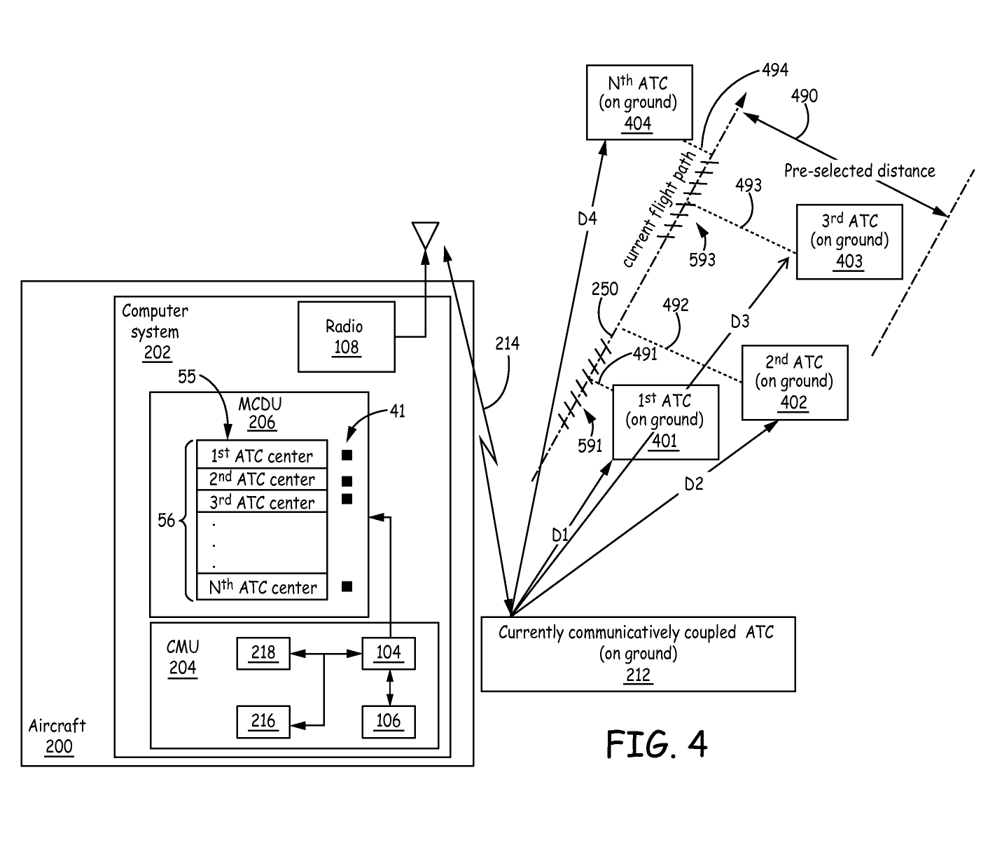

FIG. 4 is a block diagram of a specific embodiment of a computer system 202 that can implement methods of the invention shown with a flight path 250 and air traffic control centers 401-404 associated with the flight path 250. As shown in FIG. 4, the trajectory of aircraft 200 flying in accordance with a flight plan is projected onto the earth as a dashed line 250, which is referred to herein as “flight path 250”, “current flight path 250”, “primary flight path 250”, and “projected flight path 250”.

The ATC-center authority coverage area for the first ATC center 401 overlapping the flight path 250 associated with the flight plan is represented generally by the cross-hatch region 591. The ATC-center authority coverage area for the third ATC center 403 overlapping the flight path 250 is represented generally by the cross-hatch region 593. For ease of viewing, only two ATC-center authority coverage areas 591 and 593 are shown. However it is to be understood that most, if not all, of the ATC centers 401-404 have an ATC-center authority coverage area overlapping the flight path 250.

The computer system 202 is in an aircraft 200 that is preparing to travel along a flight path 250 in accordance with a flight plan. In one implementation of this embodiment, computer system 202 is in an aircraft 200 that is inflight and following the current flight path 250.

The computer system 202 includes a Multi-Control Display Unit (MCDU) 206, which is a specific type of user interface device. In other embodiments, an MFD or other display system can be used instead of MCDU 206. The MCDU 206 is used to display information to, and receive input from, the pilot and/or flight crew onboard aircraft 200. The computer system 202 also includes a radio communication device 108. The radio communication device 108 is configured to communicatively connect with an air traffic control center 212 via a data link 214. The aircraft 200 is connected to the ATC centers 401-404 via a network. In one implementation of this embodiment, Datalink Service Providers (DSPs) (e.g., ARINC and SITA) receive messages and then route them to ATC centers 401-404.

The computer system 202 includes a CMU 204, an MCDU 206, and a radio 108. The MCDU 206 includes a display 55. The CMU 204 includes a processor 104, a memory 106, and storage medium 25 including sorting software 26. The processor 104 executes sorting software 26. The memory 106 of the CMU 204 stores the flight plan for the current flight path and any alternate flight plan for an alternative flight path that may be needed, due to changes in weather for example. The alternate flight paths are known to one skilled in the art as “standby flight paths”. As shown in FIG. 1, the listing of air traffic control centers associated with the flight path 250 is displayed on the display 55 for viewing by the pilot.

Buttons 41 on the MCDU 206 are positioned with reference to the display 55 for the pilot to make a selection during a Context Management (CM) logon process. In one implementation of this embodiment, the buttons 41 are used by the pilot to select of the next air traffic control center to be communicatively coupled to when the currently coupled ATC center 212 when the aircraft 200 is out of range (or is moving out of range) of the air traffic control center 212 and/or is moving from a planned flight path to an alternate (or unplanned) flight path. In another implementation of this embodiment, the flight path is under the control of the pilot.

A subset of the air traffic control centers is generated at the processor 104. The subset is generated based on at least one of: an ATC-center authority coverage area (e.g., 591 and 593) overlapping a flight path associated with the flight plan; and a pre-selected distance from the flight path. In another implementation of this embodiment, the entire set of air traffic control centers is sorted based on a distance to the flight path associated with the filed flight plan or associated with part of the filed flight plan.

The information indicative of the ATC-center authority coverage are for each ATC center is stored in memory 106 and is accessible by the processor 104. In one implementation of this embodiment, from the long list of ATC centers, a prioritized subset is generated by determining which ATC centers 401-404 have the largest ATC-center authority coverage area (e.g., 591 and 593) overlapping a flight path 250. Those TC centers 401-404 having the largest ATC-center authority coverage area are s presented on the display 206 for the crew member.

As shown in FIG. 4, the air traffic control centers associated with the filed flight path 250 are within a pre-selected 490 from the flight path 250 projected onto the ground. In another implementation of this embodiment, from the long list of ATC centers, a prioritized subset is generated by comparing the pre-selected distance 490 to a shortest distance between the projected flight path 250 and at least one air traffic control center in the listing of air traffic control centers. Then the prioritized listing of air traffic control centers is presented on the display 206 for the crew member. The pre-selected distance 490 can be approximately the range of the radio 208 although other techniques to determine the pre-selected distance 490 can be used.

As shown in FIG. 4, the length of the line 491 is representative of the distance between the projected flight path 250 and the first ATC 401. The line 491 is perpendicular to the projected flight path 250 and extends from the projected flight path 250 to the first ATC center 401. As is known based on geometry, the shortest distance between a point and a first line is a second straight line perpendicular to the first line. The length of the line 491 is also referred to herein as “first distance 491”. The processor 104 executes software 216 to determine if the first distance 491 is less than the pre-selected distance 490. As shown in FIG. 4, first distance 491 is less than the pre-selected distance 490. Since the first distance 491 is less than the pre-selected distance 490, the processor 104 executes software 218 to display the first ATC center 401 as part of a subset 56 of the air traffic control centers within a pre-selected distance 490 from the flight path 250 associated with the flight plan.

Similarly, the processor 104 executes software 216 to determine if the length of line 492 (also referred to herein as “second distance 492”) between the flight path 250 and the second ATC center 402 is less than the pre-selected distance 490. Since the second distance 492 is less than the pre-selected distance 490, the processor 104 executes software 218 to display the second ATC center 402 as part of a subset 56 of the air traffic control centers within a pre-selected distance 490 from the flight path 250 associated with the flight plan.

The processor 104 executes software 216 to determine if the length of line 493 (also referred to herein as “third distance 493”) between the flight path 250 and the third ATC center 403 is less than the pre-selected distance 490. Since the third distance 493 is less than the pre-selected distance 490, the processor 104 executes software 218 to display the third ATC center 404 as part of the subset 56 of the air traffic control centers within a pre-selected distance 490 from the flight path 250 associated with the flight plan.

The processor 104 executes software 216 to determine if the length of line 494 (also referred to herein as “fourth distance 494”) between the flight path 250 and the N^{th} ATC center 404 is less than the pre-selected distance 490. Since fourth distance 494 is less than the pre-selected distance 490, the processor 104 executes software 218 to display the N^{th} ATC center 404 as part of a subset 56 of the air traffic control centers within a pre-selected distance 490 from the flight path 250 associated with the flight plan. This process continues until the processor 104 has evaluated each of the air traffic control centers in an accessed listing of air traffic control centers.

In one implementation of this embodiment, the processor 104 executes software 216 to sort the air traffic control centers 401-404. The sorting can be alphabetical or a rank ordering based on a distance from either the aircraft 200 during logon or the ATC center that is communicatively coupled to the aircraft 200 during logon. The sorting can also be based, not on the filed flight plan, but rather on a current flight plan within the FMS. Other types of sorting are possible. If a rank ordering is implemented based on a distance from the aircraft 200 during logon, the processor 104 executes software 216 to determine the distances D1-D4 between the currently communicatively coupled air traffic control center 212 and each of the air traffic control centers 401-404, respectively, in the subset 56. In this latter case, the processor 104 can input data from the GPS receiver 210 shown in FIG. 2.

In another implementation of this embodiment, the process is applied to only a portion of the flight plan. In this case, an initial prioritized listing is generated and displayed for a first portion of the flight path near the beginning of the flight. In this case, a second prioritized listing is generated when the aircraft has almost completed the flight along the first portion of the flight path. In yet another implementation of this embodiment, the prioritized listing is generated with additional weighting applied to the first portion of the flight path near the beginning of the flight.

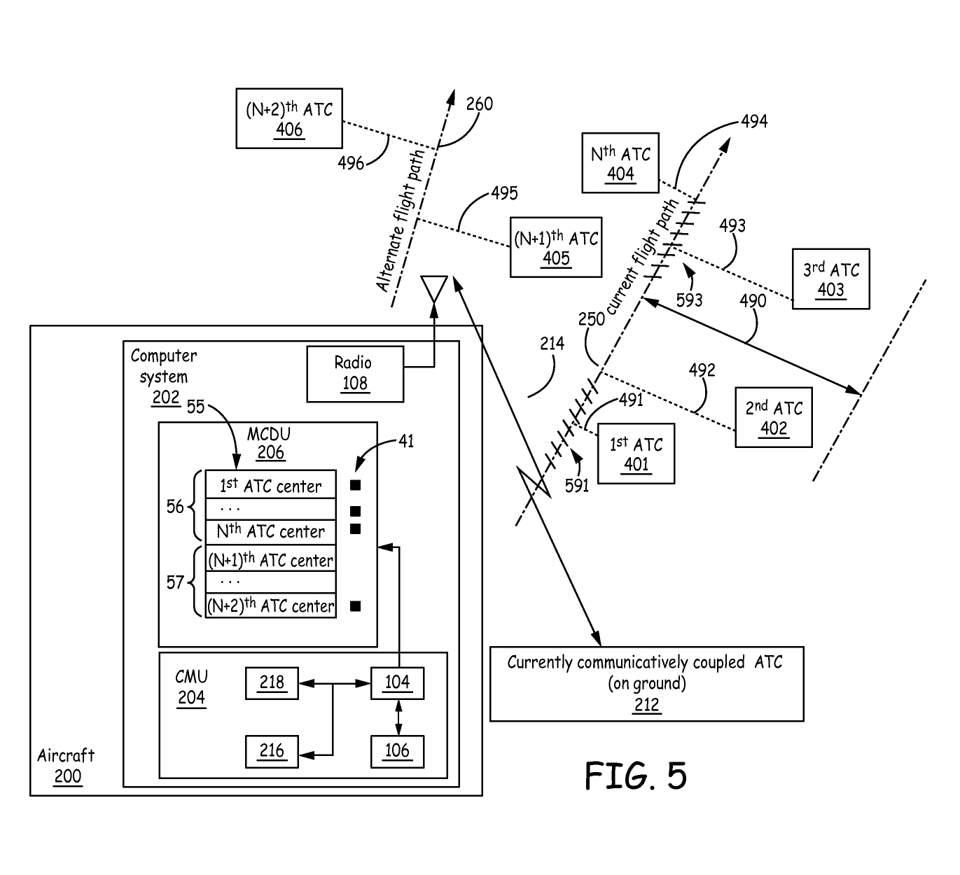

FIG. 5 is a block diagram of a specific embodiment of a computer system 202 that can implement methods of the invention shown with a flight path 250 and an alternate flight path 260 and the air traffic control centers 401-406 associated with the flight paths 250 and 260. As shown in FIG. 5, the trajectory of aircraft 200 flying in accordance with the alternate flight plan is projected onto the earth as a dashed line 260, which is referred to herein as “alternate flight path 260” or “second flight path 260”. Thus, the alternate flight path 260 is associated with an alternate flight plan for the aircraft 200. The flight path 250 is associated with the primary flight plan for the aircraft 200 as described above with reference to FIG. 4.

FIG. 5 differs from FIG. 4 in that the displayed subsets 56 and 57 include air traffic control centers for the current flight path 250 (subset 56) and air traffic control centers for the alternate flight path 260 (subset 57).

The aircraft 200 is able to transition from flying in accordance with a first flight plan to flying in accordance with a second flight plan, if circumstances require. For example, if a storm system moves into the path of the primary flight path 250, for safety reasons, the pilot changes course to proceed according to the second flight path 260 to avoid the storm. In this event, the pilot is easily able to view the air traffic control centers associated with the revised fight plan. In one implementation of this embodiment, the processor 104 is configured to reorganize the prioritized listing so that subset 57 is displayed ahead of subset 56 when the pilot changes course to follow the alternate flight plan.

The subset of air traffic control centers associated with the alternate flight plan (e.g., within a pre-selected distance from the alternate flight plan) are generated as described above with reference to the first flight plan. The processor 104 executes software 216 to determine if the length of line 495 (also referred to herein as “fifth distance 495”) between the alternate flight path 260 and the (N+1)^{th} ATC center 405 is less than the pre-selected distance 490. As shown in FIG. 5, fifth distance 495 is less than the pre-selected distance 490. Since the fifth distance 495 is less than the pre-selected distance 490, the processor 104 executes software 218 to display the (N+1)^{th} ATC center 405 as part of a second-subset 57 of the air traffic control centers within a pre-selected distance 490 from the alternate flight path 260 associated with the alternate flight plan.

The processor 104 executes software 216 to determine if the length of line 495 (also referred to herein as “sixth distance 496”) between the alternate flight path 260 and the (N+2)^{th} ATC center 406 is less than the pre-selected distance 490. As shown in FIG. 5, sixth distance 496 is less than the pre-selected distance 490. Since the sixth distance 496 is less than the pre-selected distance 490, the processor 104 executes software 218 to display the (N+2)^{th} ATC) 406 as part of a second-subset 57 of the air traffic control centers within a pre-selected distance 490 from the alternate flight path 260 associated with the alternate flight plan. The second-subset 57 is appended to the first-subset 56.

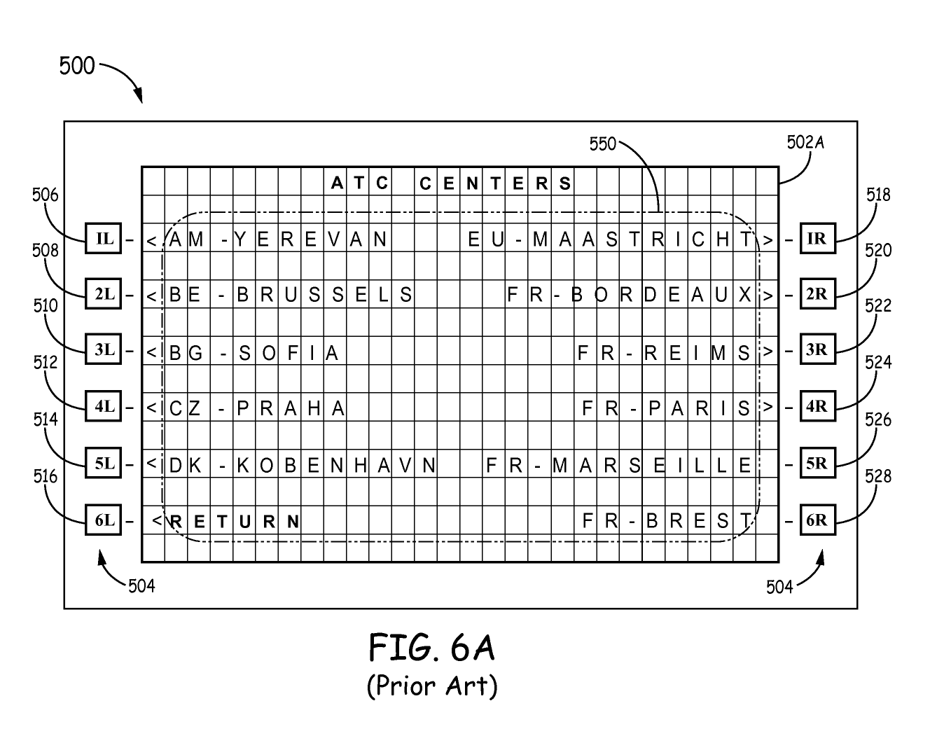

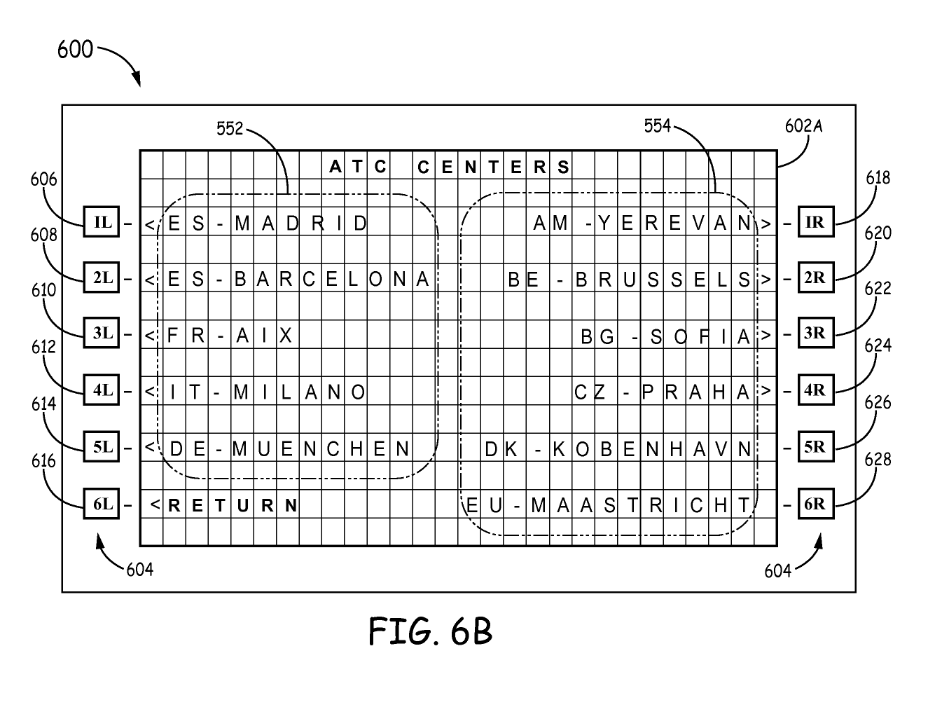

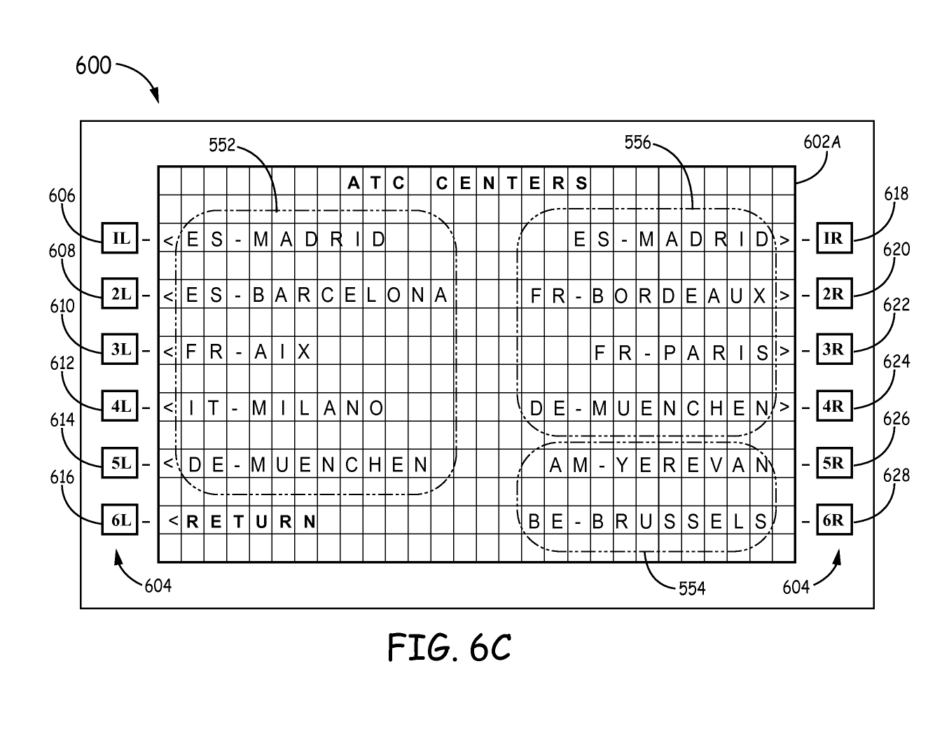

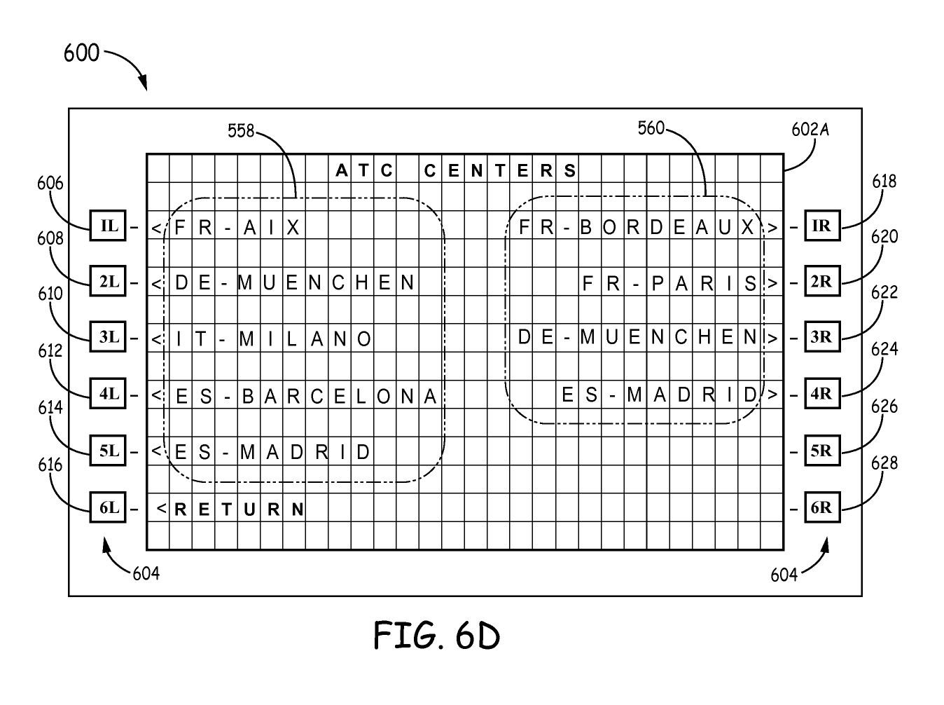

FIG. 6A depicts an exemplary prior art listing 550 of air traffic control centers on a display 500. This exemplary listing of air traffic control centers is a portion of the European Network Service Access Point (NSAP) address registry. Other listings of air traffic control centers can be used. For example, listings of air traffic control centers for other geographic locations can be used for flight plans in those other geographic locations.

FIGS. 6B-6D depict exemplary prioritized listings of air traffic control centers on an embodiment of a multi control display unit 600. FIG. 6B depicts a multi control display unit 600 showing an exemplary subset 552 of the accessed listing of air traffic control centers within a pre-selected distance from flight plan that was generated from a database for a listing (e.g., listing 550 in FIG. 6A) of air traffic control centers. The exemplary prioritized listing of FIG. 6B includes listing 552 and listing 554. The listing 552 is a subset 552 of the exemplary prior art listing 550 shown in FIG. 6A and includes the air traffic control centers that are within a pre-selected distance from a flight path as described above.

The listing 554 is a portion of the remainder of the listing of air traffic control centers in the exemplary prior art listing 550 shown in FIG. 6A. The remainder of the complete listing of air traffic control centers includes the air traffic control centers, which remain after the subset 552 is removed from the complete listing of air traffic control centers 550. Thus, the “remainder of the listing of air traffic control centers” is also referred to herein as “listing 554”. The “remainder of the listing of air traffic control centers (e.g., listing 554) is appended to the subset 552.

As shown in FIG. 6B, the subset 552 is sorted. Specifically, the air traffic control centers in the subset 552 are sorted based on a distance from the aircraft 200 to the air traffic control centers in the subset 552 as described above with reference to FIG. 4. In combination, the listings 552 and 554 form a sorted prioritized listing of air traffic control centers for a pilot who is preparing to logon in Madrid.

The multi control display unit 600 includes a plurality of buttons 604 or other appropriate input devices, such as a keyboard or keypad. Each button of the multi control display unit 600 can be associated with a particular onscreen selection. As shown on the multi control display unit 600 showing exemplary select page 602A, a button 606 is associated with a selection “ES-MADRID”, a button 608 is associated with a selection “ES-BARCELONA”, a button 610 is associated with a selection “FR-AIX”, a button 612 is associated with a selection “IT-MILANO”, a button 614 is associated with a selection “DE-MUENCHEN”, a button 616 is associated with a selection “RETURN”, a button 618 is associated with a selection “AM-YEREVAN”, a button 620 is associated with a selection “BE-BRUSSELS”, a button 622 is associated with a selection “BG-SOFIA”, a button 624 is associated with a selection “CZ-PRAHA”, a button 626 is associated with a selection “DK-KOBENHAVN”, and a button 628 is associated with a selection “EU-MAASTRICHT”. A selection of an air traffic control center can be made by the pilot and/or flight crew by pushing the appropriate button 606-614 and 618-628. In this exemplary listing, the aircraft 200 can be leaving from Madrid to fly to Munich, Germany and the subset 552 is ranked according to a distance (closest first) from Madrid, Spain.

FIG. 6C depicts an exemplary prioritized listing of air traffic control centers on an embodiment of a display 600. In this embodiment, a first-subset 552 and a second-subset 556 are displayed for current and alternate flight paths, respectively. The first-subset 552 is the same subset 552 described above with reference to FIG. 6B. The alternate flight path from Madrid, Spain to Munich, Germany is a more northern route. This is useful if the weather over the Alps is likely to cause turbulence for the aircraft 200.

The listing 556 is a second-subset 556 of the exemplary prior art listing 550 shown in FIG. 6A. The second-subset 556 of air traffic control centers includes those air traffic control centers located within the pre-selected distance from a second flight path associated with the second flight plan (alternate flight plan). The second-subset 552 of the accessed listing of air traffic control centers are also ranked according to a distance (closest first) from Madrid, Spain.

The listing 554 shown in FIG. 6C is a smaller portion of the remainder of the listing of air traffic control centers in the exemplary prior art listing 550 shown in FIG. 6A. The remainder of the complete listing of air traffic control centers includes the air traffic control centers remaining after the subsets 552 and 556 are removed from the complete listing of air traffic control centers 550. The remainder of the listing of air traffic control centers is appended to the (ranked) sorted second-subset 556. The sorted second-subset 556 is appended to the sorted first-subset 552. In combination, the listings 552, 556, and 554 form a sorted prioritized listing of air traffic control centers for a pilot, who is preparing to logon to takeoff from Madrid.

FIG. 6D depicts an exemplary prioritized listing of air traffic control centers on an embodiment of a display 600. FIG. 6D differs from FIG. 6C in that the sorted listings in FIG. 6C are not sorted. FIG. 6D also differs from FIG. 6C in that a remainder of the air traffic control centers is deleted from the prioritized listing of air traffic control centers. Thus, the listing 554 shown in FIG. 6C is not shown in FIG. 6D.

The listing 558 is the unsorted first-subset 558 of the exemplary prior art listing 550 as was also shown in FIG. 6A. The first-subset 558 of air traffic control centers includes those air traffic control centers located within the pre-selected distance from the primary flight path associated with the first flight plan. The listing 560 is an unsorted second-subset 560 of the exemplary prior art listing 550 shown in FIG. 6A. The second-subset 560 of air traffic control centers includes those air traffic control centers located within the pre-selected distance from the second flight path associated with the second flight plan (alternate flight plan). In combination, the listings 558 and 160 form a prioritized listing of air traffic control centers for a pilot, who is preparing to logon to takeoff from Madrid.

As shown in FIGS. 6B-6D, the prioritized listing of air traffic control centers is sorted with the sequence of priority flowing from top-left-side of display screen, to the bottom-left-side of display screen, to the top-right-side of the display screen, to the bottom-right-side of the display screen. In other embodiments of prioritized listing as shown in FIGS. 6B-6D, the prioritized listing of air traffic control centers is sorted with the sequence of priority flowing from top line, left side of display screen; to top line, right side of display screen; to second line left side of display screen; to second line right side of display screen; to third line, right side of display screen, etc.

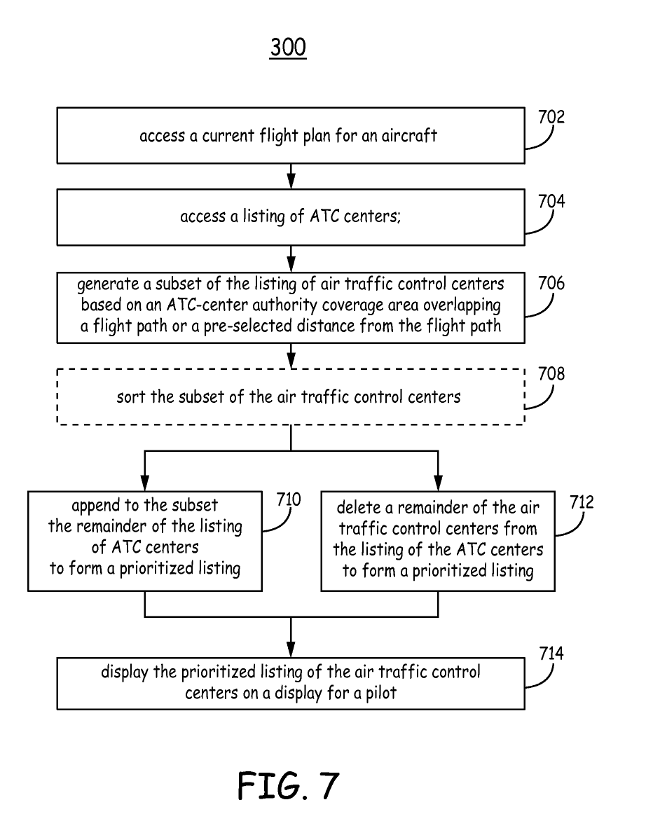

FIG. 7 shows a flow chart of an embodiment of a method 700 provide access to air traffic control centers to a crew member for logon. In one implementation of this embodiment, the logon is a context management (CM) logon. Method 700 can be implemented on any of the computer system 100 shown in FIG. 1 or the computer system 202 shown in FIGS. 2, 4, and 5 described above to provide a prioritized listing air traffic control centers that are close to the aircraft 200 as it travels along a flight path. Other embodiments are possible. The software (e.g., organization module 216 and presentation module 218) comprises a set of program instructions embodied on the storage medium from which at least a portion of the program instructions are read by the processor 104 for execution thereby. The program instructions, when executed by the processor 104, carry out at least a portion of the functionality described here as being performed by the computer system 100 or 202.

At block 702, a current flight plan for an aircraft 200 is accessed. In one implementation of this embodiment, the current flight plan is loaded into the memory 106 (FIG. 1) and the processor 104 accesses the current flight plan. In one implementation of this embodiment, more than one flight plan is loaded into the memory 106. For example, a first flight plan and an alternate second flight plan can be loaded into the memory 106. In this latter case, the first flight plan is the current flight plan and the second flight plan is an alternate flight plan.

At block 704, a listing of air traffic control centers is accessed. In one implementation of this embodiment, the listing of air traffic control centers is accessed from a database is stored in the memory 106 (FIGS. 4 and 5). In another implementation of this embodiment, the listing of air traffic control centers is accessed from a database on a removable device, such as a smart card. In yet another implementation of this embodiment, the listing of air traffic control centers is the listing 500 shown in FIG. 6A.

At block 706, a subset of the accessed listing of air traffic control centers within a pre-selected distance from flight path 250 associated with the flight plan is generated. In one implementation of this embodiment, the pre-selected distance 490 is stored in the memory 106. In another implementation of this embodiment, the pre-selected distance 490 is associated with the range of reception for the radio 208 on the aircraft 200. In yet another implementation of this embodiment, the processor 104 generates one or more of the subsets 552, 556, 558, or 560 as shown in FIGS. 6B-6D and described with reference to FIGS. 4 and 5 above. The remainder 554 of the complete listing of air traffic control centers 550 includes the air traffic control centers remaining after one or more of the subsets 552, 556, 558, or 560 are removed from the complete listing of air traffic control centers 550.

At optional block 708, the subset of the air traffic control centers are sorted. In one implementation of this embodiment, the subset of the air traffic control centers is sorted by rank ordering the subset of air traffic control centers according to rank order of the distance from the aircraft of the air traffic control centers in the subset. In another implementation of this embodiment, the processor 104 executes the software in the organization module 216 and presentation module 218 (FIGS. 2, 4, and 5) to implement the method 700.

In yet another implementation of this embodiment, a subset 558 (FIG. 6D) of air traffic control centers is sorted to form the sorted subset 552 (FIG. 6B). For example, the subset 558 is rank-ordered according distances D1-D4 from the aircraft 200 to the respective air traffic control centers 401-404 (FIG. 4) to form the sorted subset 552 (FIG. 6B).

In yet another implementation of this embodiment, the first-subset 558 (FIG. 6D) of air traffic control centers is sorted to form the sorted first-subset 552 (FIG. 6C) while the second-subset 560 (FIG. 6D) of the air traffic control centers is sorted to form the sorted second-subset 556 (FIG. 6C). For example, the subset 560 is rank-ordered according a distance from the aircraft 200 to the air traffic control centers 405-406 (FIG. 5). The flow of method 700 proceeds from block 708 to one of block 710 or 712, depending on the embodiment.

In yet another implementation of this embodiment, block 708 is not implemented and there is no sorting of the subset of air traffic control centers. In this case the flow of method 700 flows from block 706 to one of block 710 or 712. The flow of method 700 is based on a configuration of the computer system 202 and the algorithms to be executed by the processor 410.

At block 710, the remainder of the listing of air traffic control centers are appended to (added to the back of) the subset of air traffic control centers to form a prioritized listing of air traffic control centers. As defined herein, the remainder of the listing of air traffic control centers includes the list of air traffic control centers excluded from (not in) the subset and the alternate subset.

In one implementation of this embodiment, the remainder 554 of the listing of air traffic control centers is appended to the sorted subset 552 (FIG. 6B) of air traffic control centers to form a sorted prioritized listing 552/554 of air traffic control centers.

In another implementation of this embodiment, the second-subset 560 is appended to the first-subset 558 and the remainder 554 of the listing of air traffic control centers is appended to the second-subset 560 to form the prioritized listing 558/560/554 of air traffic control centers (FIG. 6D).

In yet another implementation of this embodiment, the sorted-second-subset 556 is appended to the sorted-first-subset 552 and the remainder 554 of the listing of air traffic control centers is appended to the sorted-second-subset 556 to form a sorted prioritized listing 552/556/554 of air traffic control centers (FIG. 6C).

The method 700 is now described for the embodiment in which the flow proceeds from block 708 to block 712. At block 712, a remainder of the air traffic control centers is deleted from the prioritized listing of air traffic control centers to form the prioritized listing of air traffic control centers. As defined herein, the remainder of the air traffic control centers includes those air traffic control centers that are not in any of the one or more subsets generated at block 706. Thus, the prioritized listing of air traffic control centers from which the remainder of the air traffic control centers are excluded is shown in FIG. 6D.

At block 714, the prioritized listing of air traffic control centers is displayed for a crew member so that the crew member (e.g., a pilot or co-pilot) can log onto that ATC center using an associated address. The associated address is (in the database. In another implementation of this embodiment, the associated address is a hard coded address.

### EXAMPLE EMBODIMENTS

Example 1 includes a method to provide access to air traffic control centers to a crew member for context management (CM) logon, the method comprising: accessing a flight plan for an aircraft at a processor; accessing a listing of air traffic control centers; generating a subset of the air traffic control centers at the processor, the generating being based on at least one of: an ATC-center authority coverage area overlapping a flight path associated with the flight plan; and a pre-selected distance from the flight path; and displaying the subset of the air traffic control centers as at least a part of a prioritized listing of the air traffic control centers on a display for the crew member.

Example 2 includes the method of Example 1, further comprising: sorting the subset of the air traffic control centers.

Example 3 includes the method of Example 2, wherein sorting the subset of the air traffic control centers comprises: rank ordering the subset of the air traffic control centers in the subset according to at least one of: an extent of the ATC-center authority coverage area overlapping the flight path; and distances from the aircraft to the respective air traffic control centers.

Example 4 includes the method of any of Examples 1-3, wherein the flight plan is a primary flight plan, wherein generating the subset of the air traffic control centers comprises: generating a first-subset of the air traffic control centers based on at least one of: an ATC-center authority coverage area overlapping a primary flight path associated with the primary flight plan; and the pre-selected distance from the primary flight path, the method further comprising: accessing an alternate flight plan for the aircraft; and generating a second-subset of the air traffic control centers based on at least one of: an ATC-center authority coverage area overlapping an alternate flight path associated with the alternate flight plan; and the pre-selected distance from the alternate flight path, in which air traffic control centers in the first-subset are excluded from the second-subset.

Example 5 includes the method of Example 4, further comprising: appending the second-subset to the first-subset to form the prioritized listing of the air traffic control centers.

Example 6 includes the method of Example 5, further comprising: deleting a remainder of the air traffic control centers from the listing of the air traffic control centers to form the prioritized listing of the air traffic control centers.

Example 7 includes the method of any of Examples 4-6, further comprising: appending the second-subset to the first-subset; and appending to the second-subset a remainder of the listing of the air traffic control centers excluded from the first-subset and the second-subset to form the prioritized listing of the air traffic control centers.

Example 8 includes the method of any of Examples 4-7, further comprising: sorting the first-subset of air traffic control centers; and sorting the second-subset of the air traffic control centers.

Example 9 includes the method of Example 8, wherein sorting the first-subset of the air traffic control centers comprises: rank ordering the first-subset of air traffic control centers according to at least one of: an extent of the ATC-center authority coverage area overlapping the primary flight path in the first-subset; and distances from the aircraft to the air traffic control centers in the first-subset, wherein sorting the second-subset of the air traffic control centers comprises: rank ordering the second-subset of air traffic control centers according to at least one of: an extent of the ATC-center authority coverage area overlapping the alternate flight path in the second-subset; and a distance from the aircraft to the air traffic control centers in the second-subset.

Example 10 includes the method of any of Examples 1-9, further comprising: appending to the subset a remainder of the listing of the air traffic control centers to form the prioritized listing of the air traffic control centers.

Example 11 includes the method of any of Examples 1-10, wherein accessing the flight plan for the aircraft comprises accessing the flight plan for the aircraft from a database stored in a system that hosts a Protected Mode Controller Data Link Communications (PM-CPDLC).

Example 12 includes the method of any of Examples 1-11, further comprising: deleting a remainder of the air traffic control centers from the listing of the air traffic control centers to form the prioritized listing of the air traffic control centers.

Example 13 includes a computer system, comprising: at least one processor; and at least one memory device in operative communication with the processor, the memory device comprising a computer readable medium having program instructions stored thereon for: accessing a flight plan for an aircraft; accessing a listing of air traffic control centers; generating a subset of the air traffic control centers at the processor, the generating being based on at least one of: an ATC-center authority coverage area overlapping a flight path associated with the flight plan; and a pre-selected distance from the flight path; and displaying the prioritized listing of the air traffic control centers on a display for a crew member.

Example 14 includes the computer system of Example 13, wherein the computer readable medium has further program instructions stored thereon for: sorting the subset of the air traffic control centers.

Example 15 includes the computer system of Example 14, wherein the program instructions for sorting the subset of the air traffic control centers comprises program instructions for: rank ordering the subset of the air traffic control centers in the subset according to at least one of: an extent of the ATC-center authority coverage area overlapping the flight path; and distances from the aircraft to the respective air traffic control centers.

Example 16 includes the computer system of any of Examples 13-15, wherein the flight plan is a primary flight plan, wherein the program instructions for generating the subset of the air traffic control centers comprises program instructions for: generating a first-subset of the air traffic control centers based on at least one of: an ATC-center authority coverage area overlapping a primary flight path associated with the primary flight plan; and a pre-selected distance from the primary flight path, wherein the computer readable medium has further program instructions stored thereon for: accessing an alternate flight plan for the aircraft; and generating a second-subset of the air traffic control centers based on at least one of: an ATC-center authority coverage area overlapping an alternate flight path associated with the alternate flight plan; and a pre-selected distance from the alternate flight path, in which air traffic control centers in the first-subset are excluded from the second-subset.

Example 17 includes the computer system of Example 16, wherein the computer readable medium has further program instructions stored thereon for: appending the second-subset to the first-subset.

Example 18 includes a computer program product comprising program instructions, embodied on a storage medium, that are operable to cause a processor to: access a listing of air traffic control centers; generate a subset of the air traffic control centers from the listing of the air traffic control centers, the generating being based on at least one of: an ATC-center authority coverage area overlapping a flight path associated with a flight plan; and a pre-selected distance from the flight path.

Example 19 includes the program product of Example 18, further comprising instructions operable to cause the processor to: rank order the subset of the air traffic control centers according to at least one of: an extent of the ATC-center authority coverage area overlapping the flight path in the subset; and distances from the aircraft to the air traffic control centers in the subset.

Example 20 includes the program product of any of Examples 18-19, wherein the program instructions operable to cause a processor to generate the subset of the air traffic control centers from the listing of the air traffic control centers includes program instructions operable to cause the processor to: generate a first-subset of the air traffic control centers based on at least one of: an ATC-center authority coverage area overlapping a primary flight path associated with a primary flight plan; and a pre-selected distance from the primary flight path; and generate a second-subset of the air traffic control centers based on at least one of: the ATC-center authority coverage area overlapping an alternate flight path associated with an alternate flight plan; and a pre-selected distance from the alternate flight path, in which air traffic control centers in the first-subset are excluded from the second-subset; and append the second-subset to the first-subset.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method to provide access to air traffic control centers to a crew member for context management (CM) logon, the method comprising:
accessing a flight plan for an aircraft at a processor;
accessing a listing of air traffic control centers;
generating a subset of the air traffic control centers at the processor, the generating being based on at least one of:
an ATC-center authority coverage area overlapping a flight path associated with the flight plan; and
a pre-selected distance from the flight path; and
displaying the subset of the air traffic control centers as at least a part of a prioritized listing of the air traffic control centers on a display for the crew member.

2. The method of claim 1, further comprising:
sorting the subset of the air traffic control centers.

3. The method of claim 2, wherein sorting the subset of the air traffic control centers comprises:
rank ordering the subset of the air traffic control centers in the subset according to at least one of:
an extent of the ATC-center authority coverage area overlapping the flight path; and
distances from the aircraft to the respective air traffic control centers.

4. The method of claim 1, wherein the flight plan is a primary flight plan, wherein generating the subset of the air traffic control centers comprises:
generating a first-subset of the air traffic control centers based on at least one of: an ATC-center authority coverage area overlapping a primary flight path associated with the primary flight plan; and the pre-selected distance from the primary flight path, the method further comprising:
accessing an alternate flight plan for the aircraft; and
generating a second-subset of the air traffic control centers based on at least one of: an ATC-center authority coverage area overlapping an alternate flight path associated with the alternate flight plan; and the pre-selected distance from the alternate flight path, in which air traffic control centers in the first-subset are excluded from the second-subset.

5. The method of claim 4, further comprising:
appending the second-subset to the first-subset to form the prioritized listing of the air traffic control centers.

6. The method of claim 5, further comprising:
deleting a remainder of the air traffic control centers from the listing of the air traffic control centers to form the prioritized listing of the air traffic control centers.

7. The method of claim 4, further comprising:
appending the second-subset to the first-subset; and
appending to the second-subset a remainder of the listing of the air traffic control centers excluded from the first-subset and the second-subset to form the prioritized listing of the air traffic control centers.

8. The method of claim 4, further comprising:
sorting the first-subset of air traffic control centers; and
sorting the second-subset of the air traffic control centers.

9. The method of claim 8, wherein sorting the first-subset of the air traffic control centers comprises:
rank ordering the first-subset of air traffic control centers according to at least one of: an extent of the ATC-center authority coverage area overlapping the primary flight path in the first-subset; and distances from the aircraft to the air traffic control centers in the first-subset, wherein sorting the second-subset of the air traffic control centers comprises:
rank ordering the second-subset of air traffic control centers according to at least one of: an extent of the ATC-center authority coverage area overlapping the alternate flight path in the second-subset; and a distance from the aircraft to the air traffic control centers in the second-subset.

10. The method of claim 1, further comprising:
appending to the subset a remainder of the listing of the air traffic control centers to form the prioritized listing of the air traffic control centers.

11. The method of claim 1, wherein accessing the flight plan for the aircraft comprises accessing the flight plan for the aircraft from a database stored in a system that hosts a Protected Mode Controller Data Link Communications (PM-CPDLC).

12. The method of claim 1, further comprising:
deleting a remainder of the air traffic control centers from the listing of the air traffic control centers to form the prioritized listing of the air traffic control centers.

13. A computer system, comprising:
at least one processor; and
at least one memory device in operative communication with the processor, the memory device comprising a computer readable medium having program instructions stored thereon for:
accessing a flight plan for an aircraft;
accessing a listing of air traffic control centers;
generating a subset of the air traffic control centers at the processor, the generating being based on at least one of:
an ATC-center authority coverage area overlapping a flight path associated with the flight plan; and
a pre-selected distance from the flight path; and
displaying the prioritized listing of the air traffic control centers on a display for a crew member.

14. The computer system of claim 13, wherein the computer readable medium has further program instructions stored thereon for:
sorting the subset of the air traffic control centers.

15. The computer system of claim 14, wherein the program instructions for sorting the subset of the air traffic control centers comprises program instructions for:
rank ordering the subset of the air traffic control centers in the subset according to at least one of: an extent of the ATC-center authority coverage area overlapping the flight path; and distances from the aircraft to the respective air traffic control centers.

16. The computer system of claim 13, wherein the flight plan is a primary flight plan, wherein the program instructions for generating the subset of the air traffic control centers comprises program instructions for:
generating a first-subset of the air traffic control centers based on at least one of: an ATC-center authority coverage area overlapping a primary flight path associated with the primary flight plan; and a pre-selected distance from the primary flight path, wherein the computer readable medium has further program instructions stored thereon for:
accessing an alternate flight plan for the aircraft; and
generating a second-subset of the air traffic control centers based on at least one of: an ATC-center authority coverage area overlapping an alternate flight path associated with the alternate flight plan; and a pre-selected distance from the alternate flight path, in which air traffic control centers in the first-subset are excluded from the second-subset.

17. The computer system of claim 16, wherein the computer readable medium has further program instructions stored thereon for:
appending the second-subset to the first-subset.

18. A computer program product comprising program instructions, embodied on a storage medium, that are operable to cause a processor to:
access a listing of air traffic control centers;
generate a subset of the air traffic control centers from the listing of the air traffic control centers, the generating being based on at least one of:
an ATC-center authority coverage area overlapping a flight path associated with a flight plan; and
a pre-selected distance from the flight path.

19. The program product of claim 18, further comprising instructions operable to cause the processor to:
rank order the subset of the air traffic control centers according to at least one of: an extent of the ATC-center authority coverage area overlapping the flight path in the subset; and distances from the aircraft to the air traffic control centers in the subset.

20. The program product of claim 18, wherein the program instructions operable to cause a processor to generate the subset of the air traffic control centers from the listing of the air traffic control centers includes program instructions operable to cause the processor to:
generate a first-subset of the air traffic control centers based on at least one of: an ATC-center authority coverage area overlapping a primary flight path associated with a primary flight plan; and a pre-selected distance from the primary flight path; and
generate a second-subset of the air traffic control centers based on at least one of: the ATC-center authority coverage area overlapping an alternate flight path associated with an alternate flight plan; and a pre-selected distance from the alternate flight path, in which air traffic control centers in the first-subset are excluded from the second-subset; and
append the second-subset to the first-subset.
